(19) United States
(12) Patent Application Publication
(10) Pub. No.: US 2026/0354446 A1
(43) Pub. Date: Nov. 12, 2026

(54) Tobacco Article Comprising A Resistive Layer And Associated Aerosol Generating Assembly

(71) Applicant: JT INTERNATIONAL SA, Geneva (CH)

(72) Inventor: Alec Wright, Guildford (GB)

(73) Assignee: JT INTERNATIONAL SA, Geneva (CH)

(21) Appl. No.: 19/122,872

(22) PCT Filed: Nov. 13, 2023
(86) PCT No.: PCT/EP2023/081592

§ 371 Date: Apr. 21, 2025

(30) Foreign Application Priority Data
Nov. 14, 2022 (EP) 22207240.7

(51) Int. Cl. A24D 1/20; A24D 1/02; A24F 40/20; A24F 40/46; A24F 40/57; H05B 3/14

(52) U.S. Cl. CPC A24D 1/20; A24D 1/025; A24D 1/027; A24F 40/20; A24F 40/46; A24F 40/57; H05B 3/145

(57) ABSTRACT

A tobacco article configured to operate with an aerosol generating device including a pair of electrodes includes a tobacco portion including: a substrate layer extending along an article axis (X); a resistive layer configured to generate heat when an electrical current is passed between the electrodes and extending continuously along the article axis (X) and along a transversal direction (Y) perpendicular to the article axis (X), and defining: a heat transmission surface arranged adjacent to the substrate layer to transmit heat to the substrate layer generated by the resistive layer; and a first contact surface opposite to the heat transmission surface and comprising a contacting part designed to be in electrical contact with at least one electrode.

### CROSS-REFERENCE TO RELATED APPLICATIONS

The present application is a national phase entry under 35 U.S.C. § 371 of International Application No. PCT/EP2023/081592, filed Nov. 13, 2023, published in English, which claims priority to European Application No. 22207240.7, filed Nov. 14, 2022.

### FIELD OF THE INVENTION

The present invention concerns a tobacco article comprising a resistive layer. The present invention also concerns an aerosol generating assembly comprising such a tobacco article.

Particularly, the aerosol generating assembly according to the invention comprises an aerosol generating device which is configured to operate with the tobacco article comprising for example a solid substrate able to form aerosol when being heated. Thus, such type of aerosol generating devices, also known as heat-not-burn devices, is adapted to heat, rather than burn to generate aerosol for inhalation.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device. Devices of this type generate aerosol or vapour by heating an aerosol substrate that typically comprises moist leaf tobacco or other suitable vaporizable material to a temperature typically in the range 150 °C to 350 °C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

In order to provide high user comfort, it is desirable to obtain fast and efficient heating of the aerosol substrate. Some known aerosol generating devices operating with tobacco articles comprise a heater configured to transfer heat to the aerosol substrate for its heating. However, this way of heating may not be completely efficient and may conduct to heat losses.

### SUMMARY OF THE INVENTION

One of the aims of the invention is to provide a tobacco article which can be heated in a fast and efficient way.

For this purpose, the invention relates to a tobacco article a tobacco article configured to operate with an aerosol generating device comprising a pair of electrodes;
the tobacco article extending along an article axis between a mouth end and a tobacco end, and comprising a non-tobacco portion adjacent to the mouth end and a tobacco portion adjacent to the tobacco end;
the tobacco portion comprising:
   a substrate layer extending along the article axis;
   a resistive layer configured to generate heat when an electrical current is passed between the electrodes and extending continuously along the article axis and along a transversal direction perpendicular to the article axis, and defining:
      a heat transmission surface arranged adjacent to the substrate layer to transmit heat to the substrate layer generated by the resistive layer when the resistive layer is in contact with said pair of electrodes;
a first contact surface opposite to the heat transmission surface and comprising a contacting part designed to be in electrical contact with at least one electrode of said pair of electrodes.

Thanks to these features, the resistive layer of the tobacco article can ensure the heating of the substrate layer. Since the resistive layer is comprised in the tobacco layer, it can efficiently transfer the heat to the substrate layer and thus, minimize the heat losses. For example, the resistive layer can be arranged contiguous in respect with the substrate layer so as to maximize their common contact surface. For example, the heat transmission surface can extend according to the whole surface defined by the substrate layer and facing the heat transmission surface.

Additionally, the resistive layer extends continuously along at least one axis and at least one transversal direction perpendicular to said axis. By “continuous extension” of the resistive layer, it is understood that the resistive layer has no gaps or holes in the material forming this layer, along the corresponding axis/direction. The continuous extension of the resistive layer maximizes the contact area of its heat transmission surface with the substrate layer that improves the efficiency of the heat transmission to the substrate layer.

The tobacco article and consequently, the resistive layer can have a flat-shape. The tobacco article may have a generally cuboid shape for example. In this case, the transversal direction of its continuous extension corresponds to a rectilinear axis perpendicular to the article axis and extending in the plane defining the resistive layer. In other embodiments, the tobacco article and the resistive layer can have any other suitable shape, for example a cylindrical shape having for example a substantially circular cross-section. In this case, the transversal direction can correspond to a circumferential direction of this shape.

The contacting part of the first contact surface is designed to be in direct or indirect electrical contact with the corresponding electrode. In case of a direct electrical contact, the electrode touches the contacting part without piercing the resistive layer. In case of an indirect electrical contact, an intermediate electrically conductive material is sandwiched between the contacting part and the corresponding electrode, without piercing the contacting part.

According to some embodiments, the resistive layer comprises a carbon based material, preferably made from a carbon based material.

According to some embodiments, the resistive layer comprises charcoal;
preferably the resistive layer is free of polymer.

Thanks to these features, it is possible to achieve an electrical resistivity of the resistive layer suitable for heating the substrate layer with a target temperature. The resistive layer can comprise a carbon-based material, like charcoal or graphite, which ensures its electrical resistivity. In such a case, the part of charcoal or graphite in the resistive layer can be comprised between 5% and 50%, advantageously between 8% and 40%, and preferably between 10% and 25%, of its total weight.

The resistive layer can also comprise non-carbon components such as: glycerol, propylene glycol, gellan/xanthan gum, water, CMC binder. These components can be mixed with the carbon-based material so as to form a homogeneous mixture.

In an alternative embodiment, the resistive layer can be made only from a carbon based material, like charcoal.

According to some embodiments, the resistive layer comprises graphite or consists of graphite.

The resistive layer can be free of polymer. By excluding the polymer from the resistive layer, it is possible to use a lower resistance so less voltage is required to generate the heat making it more suitable for a handheld device.

In any case, the resistive layer is free of tobacco. This means that according to the invention, only the substrate layer comprises tobacco.

The resistive layer could be formed of particles, such as charcoal particles, agglomerated with a binder. The binder can be a cellulose derivative or gum. Particularly, to manufacture such a resistive layer, carbon containing particles, such as charcoal particles, can be first mixed with at least a binder and in some cases water. In a preferred embodiment, this mixture forms a paste or dough which can then be pressed into a layer. Then, the mixture can be solidified by curing and/or drying.

According to some embodiments, the resistive layer or at least some of its components is(are) biodegradable. For example, the binder of the resistive layer can be biodegradable. The biodegradability can be defined as a biodegradability process in control composting conditions, defined for example according to the standard EN 13432.

Thanks to these features, the tobacco article has a lower impact on environment.

According to some embodiments, the electrical resistance of the resistive layer is comprised between 0.5 Ohm and 1.5 Ohm, and is advantageously substantially equal to 1 Ohm.

Thanks to these features, less voltage is required to generate heat necessary to generate aerosol.

According to some embodiments, the resistive layer extends substantially according to the whole area of a surface defined by the substrate layer along the article axis and the transversal direction.

Thanks to these features, the substrate layer can be homogenously heated. This avoids under-heated and over-heated zones which would degrade the quality of the aerosol.

According to some embodiments, the article further comprises a wrapper extending along the article axis and the transversal direction, and wrapping the substrate layer together with the resistive layer;
the wrapper defining a window demarcating the contacting part of the first contact surface of the resistive layer.

Thanks to these features, the tobacco article is ready to be used upon its extraction from a packaging. Particularly, there is no need for the user to prepare the tobacco article before its insertion into the device since the contacting part can directly or indirectly be engaged with the corresponding electrode through the window formed in the wrapper.

In some embodiments, the window of the wrapper can be formed by an aperture. In this case, the contact between the contacting part and the electrode is direct. The contact part forms thus an uncovered part of the resistive layer. The wrapper can for example be made entirely from a non-conductive material.

In some other embodiments, the window can be formed by an electrically conductive material (such as aluminium for example). In this case, the contact between the contacting part and the electrode is indirect. The wrapper can for example be made from a non-conductive material incorporating a part of a conductive material which forms the window. The conductive part may for example be glued with the non-conductive part of the wrapper prior to the wrapping.

According to some embodiments, the tobacco portion comprises only one substrate layer and only one resistive layer.

Thanks to these features, the tobacco article can form a compact shape while ensuring an efficient heat transfer inside the article from the resistive layer to the substrate layer.

According to some embodiments, the contacting part of the first contact surface is adjacent to the non-tobacco portion.

Thanks to these features, the contacting part can be arranged at one of the ends of the resistive layer according to the article axis. Thus, it is possible to maximise the area of the resistive layer creating resistance and therefore heat, when an electrical current passes through the resistive layer.

According to some embodiments, the resistive layer further defines a second contact surface extending perpendicularly to the article axis according to the transversal direction at the tobacco end and designed to be in contact with the other electrode of said pair of electrodes.

Thanks to these features, the second contact surface can be naturally uncovered by the wrapper since the wrapper extends generally around the article axis and does not cover lateral faces formed at each end of the article. Additionally, the contact between the second contact surface and the corresponding electrode can be particularly reliable due to the direction of insertion forcing the second contact surface to the electrode.

Advantageously, the second contact surface extends only along a part of such a lateral face. The other part of this face is formed by the substrate layer which is also free of wrapper. Thus, an airflow path can be formed through the substrate layer according to the article axis.

In some embodiments, the substrate layer forms airflow channels on at least one of its surfaces. For example, airflow channels can be formed on the surface of the substrate layer in contact with the resistive layer. Thus, an airflow passing through these channels during the user's inhales can be heated by the resistive layer. On the contrary, an airflow passing through airflow channels formed on the opposite surface of the substrate layer (i.e. surface which is not in contact with the resistive layer) is not heated directly by the resistive layer but only through the substrate layer.

According to some embodiments, the article forms a substantially flat-shape;
advantageously, the tobacco portion comprising a plurality of airflow channels extending along the article axis.

The flat-shape is advantageous for the invention since it allows maximising the surface of the substrate part in contact with the resistive layer. Additionally, the airflow channels as defined above can be more easily arranged and geometrically and dimensionally defined in a flat-shaped article.

The invention also relates to an aerosol generating assembly, comprising:
a tobacco article according to any one of the preceding claims;
an aerosol generating device comprising
a cavity extending along a device axis and configured to receive the tobacco article; and
a pair of electrodes arranged in the cavity to be in contact with the resistive layer of the tobacco article.

According to some embodiments, said pair of electrodes comprises a first electrode arranged on at least one lateral wall of the cavity extending along the device axis and designed to be contact with the contacting part of the first contact surface of the resistive layer.

The first electrode can slightly protrude from the lateral wall of the cavity so as to be abutted against the contacting part of the tobacco article when it is inserted into the cavity. Thus, the electrical contact between the first contact surface of the resistive layer and the first electrode can be improved. In some embodiments, the first electrode can be mounted on an elastic element such as a spring which exerts effort to the first electrode to abut it against the first contact surface.

According to some embodiments, the first electrode comprises two facing parts arranged on opposite lateral walls of the cavity.

Thanks to these features, the tobacco article can be inserted into the cavity according to at least two different orientations without affecting its operation. Particularly, for a flat-shaped tobacco article, it is clear that there are two possible orientations of inserting the article into the cavity. Provided with two facing parts, the first electrode can always be in contact with the first contact surface of the resistive layer, independently from the way of inserting the article into the cavity.

According to some embodiments, said pair of electrodes further comprises a second electrode forming at least partially an abutting wall of the cavity and extending perpendicularly to the device axis.

The second electrode can extend according to the whole area of the corresponding lateral face of the tobacco article. Thus, it can be in contact with the second contact surface of the resistive layer, independently from the way of inserting the article into the cavity. Additionally, the second electrode can define one or several holes for an airflow passing through the substrate layer. When the substrate layer is provided with airflow channels, the holes in the second electrode are arranged to face these channels.

According to some embodiments, the aerosol generating device further comprises a controller configured to control the temperature of the substrate layer by measuring the electrical resistance of the resistive layer.

Thanks to these features, the operation of the aerosol generating device can be directly controlled using the measurements of the electrical resistance. For example, the temperature of the substrate layer can be directly derived from these measurements. Thus, there is no necessity to provide additional sensors, as a temperature sensor, to ensure the control of the aerosol generating device.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of an aerosol generating assembly according to the invention, the aerosol generating assembly comprising an aerosol generating device and a tobacco article according the invention, the tobacco article being extracted from the aerosol generating device;

FIG. 2 is a perspective view of the tobacco article of FIG. 1;

FIG. 3 is different views (A: top, B: front, C: bottom) of the tobacco article of FIG. 2;

FIG. 4 is a cross-sectional view of the tobacco article of FIG. 2 according to the plane IV; and

FIG. 5 is a schematic view of the aerosol generating assembly of FIG. 1 where the tobacco article is inserted in the device.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of a heater element explained in further detail below. The device may be portable. “Portable” may refer to the device being for use when held by a user. The device may be adapted to generate a variable amount of aerosol, e.g. by activating the heater element for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

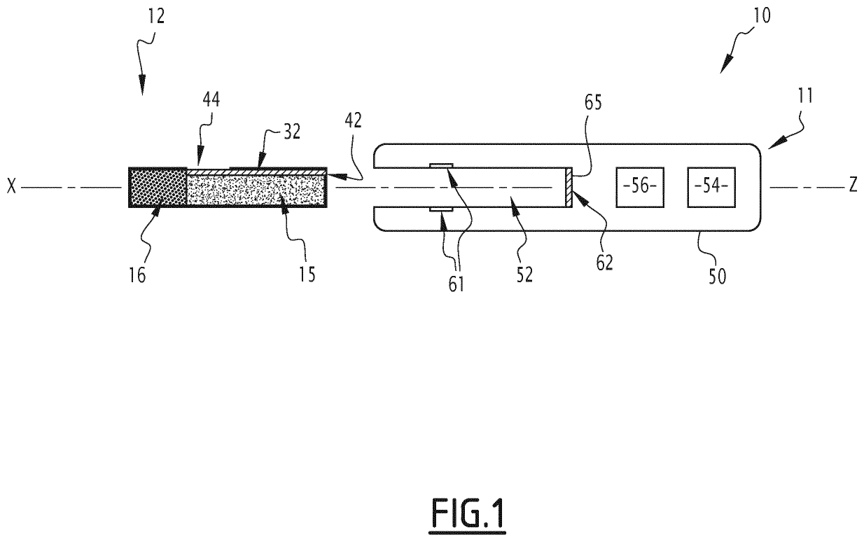

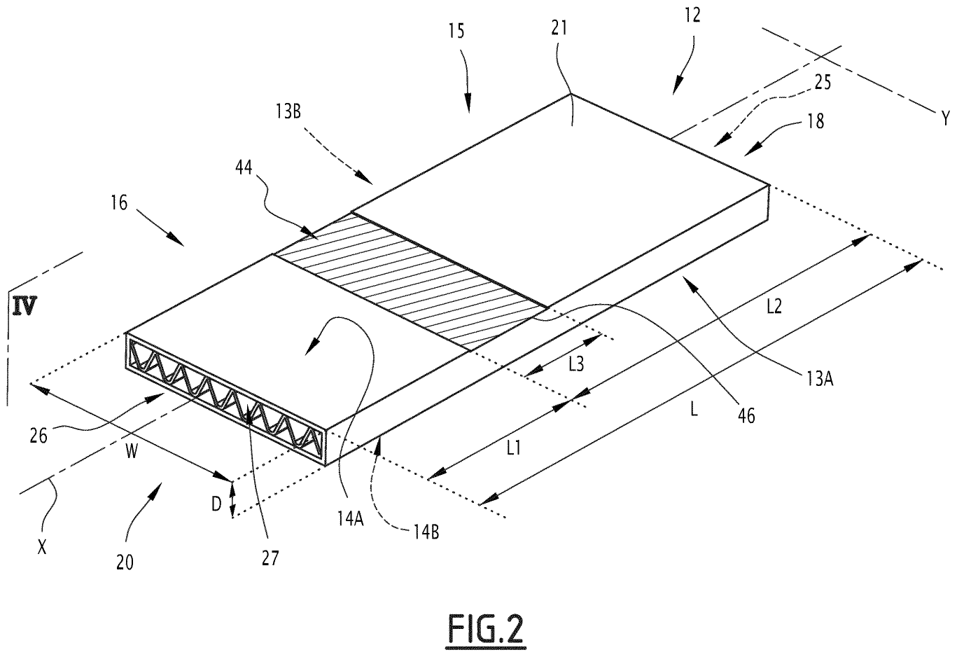

FIG. 1 shows an aerosol generating assembly 10 comprising an aerosol generating device 11 and a tobacco article 12. The aerosol generating device 11 is intended to operate with the tobacco article 12 which is shown in more detail in FIGS. 2 to 4.

The tobacco article 12 extends along an article axis X and a transversal direction Y perpendicular to the article axis X. In the example of FIGS. 2 to 4, the tobacco article 12 has a flat shape and its transversal direction Y presents a rectilinear axis which is perpendicular to the article axis X and forms with this article axis X an extension plane of the tobacco article 12. By “flat shape” of such a tobacco article it is understood that its depth (i.e. dimension extending perpendicularly to the extension plane) is several times less (for example at least 5 times or at least 10 times) than its any other dimension measured in the extension plane (as for example length or width), According to other embodiments, the tobacco article 12 presents any other suitable shape, as for example a cylindrical shape having a substantially circular cross-section. In this last case, the transversal direction Y is understood as a circumferential direction extending around the article axis X.

In reference to FIG. 2, the tobacco article 12 presents a cuboid extending along the article axis X and having external dimensions L×W×D. In a typical example, the length L of the article 12 according to the article axis X equals substantially to 33 mm while its width W and depth D are substantially equal respectively to 12 mm and 1.2 mm. According to different examples, the values L, W and D can be selected within a range of +/−40%, for example. The depth D of the tobacco article 12 is formed by a pair of parallel walls 13A, 13B, called hereinafter narrow walls 13A, 13B, and the width W of the substrate is formed by a pair of parallel walls 14A, 14B, called hereinafter wide walls 14A, 14B. In some embodiments, the edges between the wide and narrow walls 13A, 13B, 14A, 14B can be rounded.

The tobacco article 12 comprises a tobacco portion 15 and a non-tobacco portion 16 arranged successively along the article axis X. The tobacco portion 15 may for example be longer than the non-tobacco portion 16. For example, the length L2 of the tobacco portion 15 according to the article axis X may be substantially equal to 25 mm and the length L1 of the non-tobacco portion 16 according to the article axis X may be substantially equal to 8 mm. These dimensions are given only as examples and can vary considerably depending on different examples of the invention. The tobacco portion 15 defines a tobacco end 18 of the article 12 and the non-tobacco portion 16 defines a mouth end 20 of the article 12. The tobacco portion 15 and the non-tobacco portion 16 may be fixed one to the other by a wrapper 21 extending around the substrate axis X. The wrapper 21 forms the narrow and wide walls 13A, 13B, 14A, 14B of the tobacco article 12. In some embodiments, the wrapper 21 is formed from a same wrapping sheet. In some other embodiments, the wrapper 21 is formed by separate wrapping sheets wrapping separately the portions 15, 16 and fixed one to the other by any other suitable mean. The wrapper 21 may, for example, comprise paper and/or non-woven fabric and/or aluminium foil. In some embodiments, the wrapper 21 is formed entirely from a non-conductive material. In some other embodiments, the wrapper 21 is formed partially from a conductive material and partially from a non-conductive material, as it will be explained in further detail below. The wrapper 21 may be porous or air impermeable and forms a plurality of airflow channels extending inside the article 12 between the tobacco end 18 and the mouth end 20. Advantageously, the wrapper 21 does not cover transversal faces 25, 26 of the tobacco article 12 extending perpendicularly to the article axis X and formed respectfully by the tobacco portion 15 at the tobacco end 18 and the non-tobacco portion 16 at the mouth end 20.

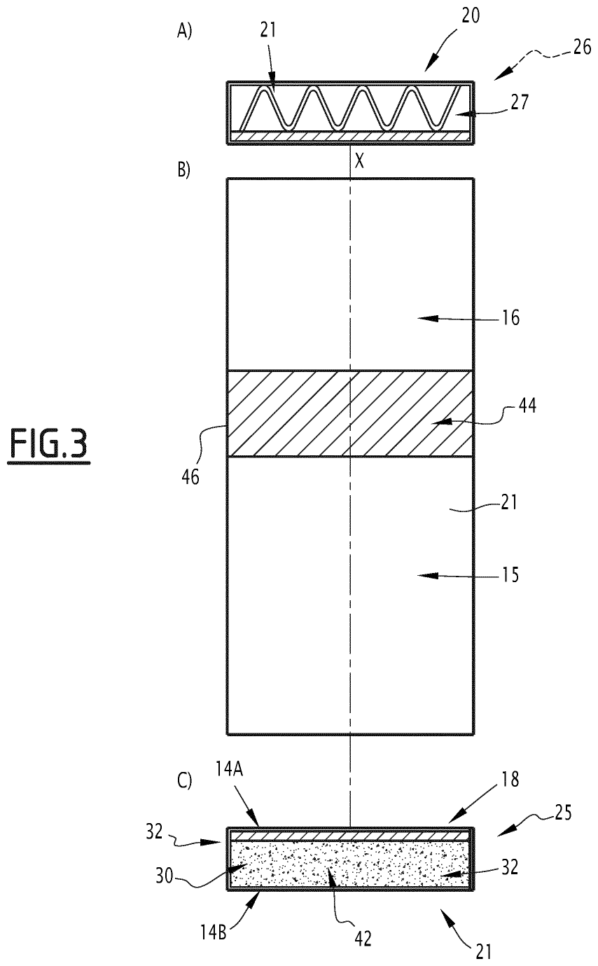

The non-tobacco portion 16 comprises a core 27 also shown in part A of FIG. 3 corresponding to a top view of the tobacco article 12. The core 27 is intended to act for example as a cooler to cool slightly the vapour before it is inhaled by the user and may comprise for this purpose for example corrugated paper. The core 27 may be formed through an extrusion and/or rolling process into a stable shape. Advantageously, the core 27 is arranged inside the non-tobacco portion 16 to be entirely in contact with the internal surface of the wrapper 21 delimiting this non-tobacco portion 16, as it is shown in part A of FIG. 3. In other words, no gap is formed in the non-tobacco portion 16 between the internal surface of the wrapper 21 and the core 27. The non-tobacco portion 16 is for example intended to be in direct contact with the user's mouth or to be received in a separate mouthpiece.

In a particular embodiment of the invention (not shown), the non-tobacco portion 16 defines a plurality of venting holes arranged for example according to the whole perimeter of the non-tobacco portion 16 along two axis perpendicular to the article axis X. In other words, according to this particular embodiment, the venting holes are arranged on each wall of the substrate among the narrow walls 13A, 13B and the wide walls 14A, 14B. According to another example, the venting holes are arranged only on the wide walls 14A, 14B or preferably, only on one of the wide walls 14A, 14B. In both examples, the venting holes may be aligned perpendicularly to the article axis X on the or each corresponding wall of the article 12, and can be spaced by a same distance. The venting holes allow fresh air entering inside the article 12 to achieve particular vaping/tasting effects. In a preferred embodiment of the invention, no venting hole is provided.

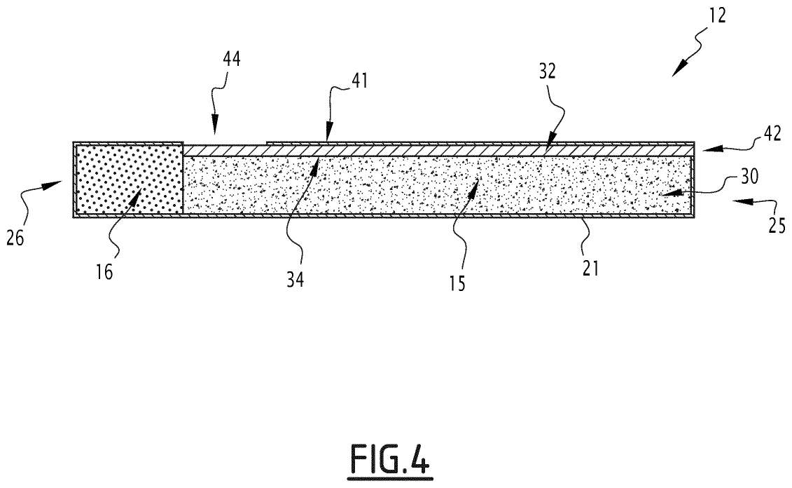

The tobacco portion 15 presents a double-layer structure. As it is shown in part C of FIG. 3 corresponding to a bottom view of the tobacco article 12 and in FIG. 4 corresponding to its longitudinal cross-section, the tobacco portion 15 comprises a substrate layer 30 and a resistive layer 32. Advantageously, no other layer is provided in the tobacco portion 15.

The substrate layer 30 comprises a vaporizable material as defined above. Notably, the substrate layer 30 comprises shredded tobacco and/or tobacco particles.

In a possible embodiment, the substrate layer is formed of pressed layer of aerosol material comprising tobacco particles and/or inhalable agent, which contains at least one of stimulant and/or flavor, a gelling agent for gelling the material and a degradation preventing and/or thickening stabilizer and an aerosol forming agent such as described in WO 2021094365. The gelling agent may be a non-protein containing polysaccharide and/or comprise gellan gum, lecithin, agar or mixtures thereof. The aerosol former may be comprised between 20 and 70 wt. % of the total weight of the vaporizable material. The aerosol forming agent may be glycerol, propylene glycol, ethanol, water or combinations thereof. The degradation preventing and/or thickening stabilizer may be carboxymethylcellulose and/or hydroxy alkylated carbohydrates. Preferably, it is purified CMC such as Ceroga 4550 C or CEOKOL 2000 (C.E. Roeper GmBH).

The substrate layer 30 extends inside the tobacco portion 15 along the article axis X and forms two opposite sides. Particularly, the substrate layer 30 is arranged so as one of its sides is in contact with the wrapper 21 and the other side is in contact with the resistive layer 32. In some embodiments, the substrate layer 30 further comprises airflow channels extending along the article axis X, for example on at least one or both of its surfaces. The airflow channels can be formed by extruding of the vaporizable material or by stamping.

The resistive layer 32 forms a layer extending continuously along the article axis X and the transversal direction Y. For example, the resistive layer 32 can extend according to the whole area of the substrate layer 30. Particularly, the resistive layer 32 forms a heat transmission surface 34 which is at least partially in contact with the substrate layer 30 and designed to transmit heat from the resistance layer 32 to the substrate layer 30.

The resistive layer 32 comprises an electrically resistive material which is able to generate heat upon passing an electrical current through this layer when it is engaged between two external electrodes. The resistive layer 32 can comprise a carbon-based material, like charcoal, which ensures its electrical resistivity. In such a case, the part of charcoal in the resistive layer can be comprised between 5% and 50%, advantageously between 8% and 40%, and preferably between 10% and 25%, of its total weight.

In order to be engaged between two external electrodes, the resistive layer 32 defines a first contact surface 41 and a second contact surface 42.

The first contact surface 41 is opposite to the heat transmission surface 34 and comprises a covered part which is covered by the wrapper 21 and a contacting part 44 which is designed to be in contact with an external electrode. Particularly, as it shown in FIGS. 2 to 4, the contacting part 44 can be formed by a part of the first contact surface 41 which faces a window 46 formed in the wrapper 21. In some embodiments, the window 46 can be formed by an aperture in the wrapper. In this case, the contacting part 44 is free of wrapper (i.e. forms an uncovered part) and is designed to be directly in contact with the external electrode. In some other embodiments, the window 46 is formed by an electrically conductive material. In this case, the contacting part 44 is designed to be in contact with the external electrode through the conductive material. Advantageously, the window 46 is formed on a wide wall 14A, 14B of the article 12 in the part of the wrapper 21 which covers the tobacco portion 15 adjacent or on a border with the non-tobacco portion 16. The window 46 can have a rectangular shape and extend according to the whole width of the corresponding wide wall 14A, 14B. The length L3 of the window 46 according to the article axis X is for example at least 50%, advantageously 70% and preferably 80% or 90%, less than the length L2 of the tobacco portion 15.

The second contact surface 42 is formed by the part of the resistive layer 32 forming the transversal face 25 of the tobacco article 12 on its tobacco end 18. The second contact surface 42 is not covered by the wrapper 21 and extends perpendicularly to the first contact surface 41 at an opposite end of the resistive layer 32. Thus, the distance between the first contact surface 41 and the second contact surface 42 within the resistive layer 32 can be maximised.

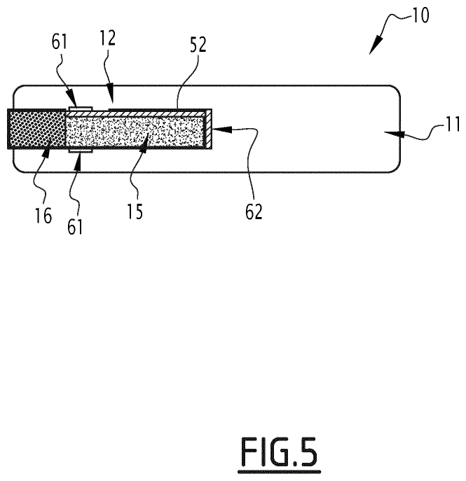

Referring again to FIG. 1, the aerosol generating device 11 comprises a device body 50 defining a cavity 52 extending along a device axis Z and configured to receive at least partially the tobacco article 12. Particularly, the cavity 52 forms a complementary shape to the shape of the tobacco article 12. Additionally, in case of a flat-shaped tobacco article, the cavity 52 is configured to receive the tobacco article 12 according to two different ways in which the article axis X coincides with the device axis Z and the non-tobacco portion 16 protrudes from the cavity 52 or is arranged in the cavity's opening as it is shown in FIG. 5. The two different ways of insertion of the tobacco article 12 are obtained one from the other by rotation the tobacco article 12 around the article axis X by 180°.

The device body 50 delimits an internal space of the device 11 receiving various elements designed to carry out different functionalities of the device 11. This internal space can for example receive a battery 54 for powering the device 11 and a controller 56 for controlling the operation of the device 11.

The aerosol generating device 11 further comprises a pair of electrodes designed to be engaged with the resistive layer 32. Particularly, the pair of electrodes comprises a first electrode 61 designed to be in contact with the first contact surface 41 of the resistive layer 32 and a second electrode 62 designed to be in contact with the second contact surface 42 of the resistive layer 32.

As it is shown in FIG. 1, the second electrode 62 can form at least partially an abutting wall 65 of the cavity 52. The abutting wall 65 is perpendicular to the device axis Z and is designed to enter in contact with the transversal face 25 formed on the tobacco end 18 of the article 12 when the article is received in the cavity 52. Advantageously, the second electrode 62 is arranged to be in contact with the second contact surface 42 of the resistive layer 32 independently from the insertion way of the tobacco article 12. For this purpose, the abutting wall 65 can be formed entirely by the second electrode 62 and the second electrode 62 can form one or several holes. These holes face the substrate layer 30 when the article 12 is inserted in the cavity 52 and form an inlet to the airflow channels formed by this substrate layer 30. These holes can be formed for example at a central part of the second electrode 62. According to another embodiment, the second electrode 62 is formed by two different parts spaced one from the other at the centre of the abutting wall 62 to form between these parts an inlet to the airflow channels formed by the substrate layer 30.

The first electrode 61 is integrated in a lateral wall of the cavity 52 to be in electrical contact with the contacting part 44 of the first contact surface 41 when the tobacco article 12 is inserted into the cavity 52. Particularly, as shown in FIG. 5, the first electrode 61 is arranged parallel to the device axis Z so as to be aligned with the contacting part 44 of the first contact surface 41 when the tobacco article 12 is inserted into the cavity. As show in FIGS. 1 and 5, in case of a flat-shaped tobacco article 12, the first electrode 61 can form two facing parts arranged on opposite lateral walls of the cavity 52. Thus, the contacting part 44 of the second contact surface 42 can be in contact with the one of these parts independently from the insertion way of the tobacco article 12 into the cavity 52. Each part of the first electrode 61 can have substantially the same dimensions and the same shape as the window 46 of the wrapper 21. Additionally, each part of the first electrode 61 can slightly protrude from the corresponding lateral wall of the cavity 52 so as to be abutted against the contacting part 44 of the second contact surface 42 when the tobacco article 12 is inserted into the cavity 52. In some embodiments, for this purpose, each part of the first electrode 61 can be mounted on an elastic element. In some embodiments, each part of the first electrode 61 forms a flat and a substantially smooth surface which is designed to enter in electrical contact with the contacting part 44 of the first contact surface 41.

The electrodes 61, 62 are connected to the battery 54 via the controller 56. The controller 56 is thus able to control the power on each electrode 61, 62 and consequently, the current passing through the resistive layer 32 and the heat generated by this layer. In some embodiments, the controller 56 is configured measure the resistance of the resistive layer 32 and based on these measurements, control the temperature of the substrate layer 30 by controlling the power on the electrodes 61, 62. The measure of resistance can be correlated to the value of temperatures such as by using a lookup table stored in the memory of the controller 56. The resistance and temperature control may be used to ensure that the heating remains inside a safety range of temperatures and/or to control a particular temperature profile is followed during the vaping session.

1. A tobacco article configured to operate with an aerosol generating device comprising a pair of electrodes;
the tobacco article extending along an article axis (X) between a mouth end and a tobacco end, and comprising a non-tobacco portion adjacent to the mouth end and a tobacco portion adjacent to the tobacco end;
the tobacco portion comprising:
a substrate layer extending along the article axis (X); and
a resistive layer configured to generate heat when an electrical current is passed between the electrodes and extending continuously along the article axis (X) and along a transversal direction (Y) perpendicular to the article axis (X), and defining:
a heat transmission surface arranged adjacent to the substrate layer to transmit heat to the substrate layer generated by the resistive layer when the resistive layer is in contact with said pair of electrodes, and
a first contact surface opposite to the heat transmission surface and comprising a contacting part configured to be in electrical contact with at least one electrode of said pair of electrodes.

2. The tobacco article according to claim 1, wherein the resistive layer comprises a carbon based material.

3. The tobacco article according to claim 2, wherein the resistive layer comprises charcoal.

4. The tobacco article according to claim 1, wherein the electrical resistance of the resistive layer is between 0.5 Ohm and 1.5 Ohm.

5. The tobacco article according to claim 1, wherein the resistive layer extends substantially according to the whole area of a surface defined by the substrate layer along the article axis (X) and the transversal direction (Y).

6. The tobacco article according to claim 1, further comprising a wrapper extending along the article axis (X) and the transversal direction (Y), and wrapping the substrate layer together with the resistive layer;
the wrapper defining a window demarcating the contacting part of the first contact surface of the resistive layer.

7. The tobacco article according to claim 1, wherein the tobacco portion comprises only one substrate layer and only one resistive layer.

8. The tobacco article according to claim 1, wherein the contacting part of the first contact surface is adjacent to the non-tobacco portion.

9. The tobacco article according to claim 1, wherein the resistive layer further defines a second contact surface extending perpendicularly to the article axis (X) according to the transversal direction (Y) at the tobacco end and configured to be in contact with the other electrode of said pair of electrodes.

10. The tobacco article according to claim 1, forming a substantially flat-shape.

11. An aerosol generating assembly, comprising:
a tobacco article according to claim 1;
an aerosol generating device comprising:
a cavity extending along a device axis (Z) and configured to receive the tobacco article; and
the a pair of electrodes arranged in the cavity configured to be in contact with the resistive layer of the tobacco article.

12. The aerosol generating assembly according to claim 11, wherein said pair of electrodes comprises a first electrode arranged on at least one lateral wall of the cavity extending along the device axis (Z) and configured to be contact with the contacting part of the first contact surface of the resistive layer.

13. The aerosol generating assembly according to claim 12, wherein the first electrode comprises two facing parts arranged on opposite lateral walls of the cavity.

14. The aerosol generating assembly-(10) according to claim 12, wherein said pair of electrodes further comprises a second electrode forming at least partially an abutting wall of the cavity and extending perpendicularly to the device axis (Z).

15. The aerosol generating assembly according to claim 11, wherein the aerosol generating device further comprises a controller configured to control the temperature of the substrate layer by measuring the electrical resistance of the resistive layer.

16. The tobacco article according to claim 3, wherein the resistive layer is free of polymer.

17. The tobacco article according to claim 10, wherein the tobacco portion comprises a plurality of airflow channels extending along the article axis (X).
